(19) United States
(12) Patent Application Publication
(10) Pub. No.: US 2024/0035523 A1
(43) Pub. Date: Feb. 1, 2024

(54) Shockload Torque Protection Device with Electrical Control Function

(71) Applicant: Beijing Lixin Dehua Technology Co., Ltd., Beijing (CN)

(72) Inventor: Quan Sun, Beijing (CN)

(73) Assignee: Beijing Lixin Dehua Technology Co., Ltd., Beijing (CN)

(21) Appl. No.: 17/956,837

(22) Filed: Sep. 30, 2022

(30) Foreign Application Priority Data
Jul. 29, 2022 (CN) 202210904363.2

(51) Int. Cl. F16D 7/02; F16D 48/06

(52) U.S. Cl. CPC F16D 7/024; F16D 48/06; F16D 2500/3027; F16D 2500/30404

(57) ABSTRACT

The present invention discloses a torque shock load device with a control function, and relates to the field of torque shock load protection, comprising a housing which is provided with an installation passage penetrating through the housing; a shaft connecting sleeve which is movably nested on the right part of the installation passage; a plurality of pressing pieces and a plurality of friction plates which are arranged alternately; a connecting piece which is installed on the left end of the housing; a detection mechanism which is installed on the shaft connecting sleeve; and a main control machine which is communicatively connected with the detection mechanism. In the present invention, the detection mechanism is installed on the shaft connecting sleeve.

### TECHNICAL FIELD

The present invention relates to the field of torque shock load protection, and particularly to a torque shock load device with a control function.

### BACKGROUND

The description of the background in the present application belongs to the related art relevant to the present application, is only used to illustrate and facilitate understanding of the application content of the present application, and shall not be interpreted as the prior art of the present application on the application date of the first proposed application as clearly considered by the applicant or presumed to be considered by the applicant.

The protection for maintenance of safety of machines and equipment is needed when a shock load exceeds a certain limit value. In the related fields of large equipment, military equipment, energy equipment and mining, torque and vibration are important working parameters in rotary power machinery. In various industrial fields, especially in the use environment with adverse conditions, the use places include various fields that involve power transmission; the conditions such as sudden unpredictable load and vibration change in transmission equipment, or abnormal stagnation at work ends, sudden blocking and stop, equipment strain and structural instability may cause vibration and significant shock loads, thereby causing influence or even uncorrectable damage to the life and performance of the complete set of transmission system. At present, most of the torque shock load devices adjust a friction torque transferred by a friction pair which wears with each other to a shock load protection torque. When shock load occurs, the friction pair skids, to play a role of safety protection.

At present, there are some torque shock load protection devices in the market, which can achieve the effect of shock load protection, but the existing products cannot display the internal torque data and users cannot know the actual effect of the torque shock load device in real time through the data.

Therefore, it is necessary to invent a torque shock load device with a control function to solve the above problems.

### SUMMARY

The purpose of the present invention is to provide a torque shock load device with a control function to solve the problems proposed in the above background that the existing products cannot display the internal torque data and users cannot know the actual effect of a torque shock load device in real time through the data.

To achieve the above purpose, the present invention provides the following technical solution: a torque shock load device with a control function comprises:
a housing, wherein the housing is provided with an installation passage penetrating through the housing and the right end of the housing is provided with an end cover;
a shaft connecting sleeve, wherein the shaft connecting sleeve is movably nested on the right part of the installation passage and the shaft connecting sleeve movably penetrates through the end cover;
pressing pieces and friction plates, wherein the number of the pressing pieces and the number of the friction plates are multiple; a plurality of pressing pieces are installed on the right part of the installation passage through splines; a plurality of friction plates are installed on the shaft connecting sleeve through splines; and the plurality of friction plates and the plurality of pressing pieces are arranged alternately;
a connecting piece which is installed on the left end of the housing;
a detection mechanism which is installed on the shaft connecting sleeve;
a main control machine which is communicatively connected with the detection mechanism.

Preferably, the connecting piece comprises a connecting part, a flange and a connecting column; the connecting column is installed in the middle of the left side of the connecting part; the flange is fixedly sleeved on the left end of the outer side of the connecting column; the connecting part is nested in the left part of the installation passage; the middle of the connecting column is provided with a connecting hole; and the right end of the connecting hole extends to the right side wall of the connecting part. The flange or the connecting hole is convenient to connect the connecting piece with a transmission shaft of an external device, and the connection is convenient.

Preferably, the outer side wall of the connecting part and the inner wall of the installation passage are connected by splines, and the housing and the connecting part are connected by bolts, so that the connection between the connecting part and the housing is firm and stable, and stress is uniform.

Preferably, the detection mechanism is located on the right side of the end cover; the detection mechanism comprises a bearing pedestal, a torque temperature collection device and a vibration quantity detection device; and the vibration quantity detection device is installed on the right side of the bearing pedestal. The torque temperature collection device can detect the temperature and the torque of the shaft connecting sleeve, and the vibration quantity detection device can detect the axial and radial vibration quantities of the shaft connecting sleeve.

Preferably, the torque temperature collection device comprises a protective box, a torque sensor and a temperature sensor; a first wireless communication module, a first single chip microcomputer, a signal processing circuit unit, an analog/digital conversion unit and an encoder are installed inside the protective box; the output end of the torque sensor is electrically connected with the input end of the signal processing circuit unit; the output end of the signal processing circuit unit is electrically connected with the input end of the analog/digital conversion unit; the output end of the analog/digital conversion unit is electrically connected with the input end of the encoder; the output end of the encoder is electrically connected with the input end of the first single chip microcomputer; and the first single chip microcomputer is communicatively connected with the main control machine through the first wireless communication module. The torque sensor can collect the twisting force of the shaft connecting sleeve, and then send the twisting force to the main control machine through the second wireless communication module.

Preferably, the output end of the temperature sensor is electrically connected with the input end of the first single chip microcomputer, and a first power supply is arranged inside the protective box. The temperature of the shaft connecting sleeve can be detected through the temperature sensor, and then sent to the main control machine through the second wireless communication module. The first power supply provides electricity for the work of electrical elements in the torque temperature collection device.

Preferably, the vibration quantity detection device comprises an arc bracket; the arc bracket is fixed on the right side wall of the bearing pedestal; eddy current probes are installed on the arc bracket; the number of the eddy current probes is two; two eddy current probes are radially installed in the same plane perpendicular to an axis; the two eddy current probes are arranged by 90 degrees; an installation cavity is arranged inside the arc bracket; a second single chip microcomputer, a second power supply and a second wireless communication module are arranged inside the installation cavity; the output ends of the eddy current probes are electrically connected with the input end of the second single chip microcomputer; and the second single chip microcomputer is communicatively connected with the main control machine through the second wireless communication module. The two eddy current probes can detect the axial and radial vibration quantities of the shaft connecting sleeve, collect the vibration quantity data of the shaft connecting sleeve, and send the data to the main control machine through the second wireless communication module.

Preferably, the surface of the main control machine is provided with a display screen and a control button panel; a processor and a third wireless communication module are arranged inside the main control machine; the processor is communicatively connected with the third wireless communication module; the output end of the processor is electrically connected with the input end of the display screen; and the output end of the control button panel is electrically connected with the input end of the processor. The main control machine can collect data information sent by the detection mechanism, the torque temperature collection device and the vibration quantity detection device, and display the data information on the display screen, which is convenient for users to view. Moreover, the main control machine can control the work of the detection mechanism, the torque temperature collection device and the vibration quantity detection device.

Preferably, a buzzer is arranged inside the main control machine, and the output end of the processor is electrically connected with the input end of the buzzer. When the detected temperature is too high or the torque is quite different from a set value or the vibration quantity is too large, the buzzer rings to provide an alarm to remind the users, so that the users can conveniently stop the machine for maintenance.

Preferably, the right side surface of the pressing piece located at a rightmost end is abutted against the end cover, and the left side surface of the pressing piece located at a leftmost end is abutted against the right side surface of the connecting part. The friction plate located at the rightmost end is separated from the end cover through the pressing pieces, to avoid friction due to the contact between the friction plate located at the rightmost end and the end cover, and reduce the wear of the end cover. The friction plate located at the leftmost end is separated from the connecting part through the pressing pieces to reduce the wear of the connecting part.

In the above technical solution, the present invention provides the following technical effects and advantages:

1. The detection mechanism is installed on the shaft connecting sleeve. The detection mechanism comprises the torque temperature collection device and the vibration quantity detection device. The main control machine can control the work of the torque temperature collection device and the vibration quantity detection device. The torque temperature collection device and the vibration quantity detection device can detect the temperature and the torque of the shaft connecting sleeve, can detect the axial and radial vibration quantities of the shaft connecting sleeve and can wirelessly transmit the detection data to the main control machine, so that customers can intuitively understand the temperature, torque data and vibration quantities of the shaft connecting sleeve to facilitate the customers to adjust a power mechanism according to the detection data.

2. The buzzer is arranged inside the main control machine. When the detected temperature is too high or the torque is quite different from the set value or the vibration quantity is too large, the buzzer in the main control machine rings to provide an alarm to remind the users, so that the users can conveniently stop the machine for maintenance.

3. The detection mechanism is connected with the main control machine through a wireless connection mode, and wireless communication is adopted to reduce the trouble and interference of wiring, so that the assembly is more simple and convenient.

4. The torque temperature collection device and the vibration quantity detection device do not interfere with each other, and when any one is damaged, the other one can work normally.

### DESCRIPTION OF DRAWINGS

To more clearly describe the technical solutions in the embodiments of the present application or in the prior art, the drawings required to be used in the embodiments will be simply presented below. Apparently, the drawings in the following description are merely some embodiments recorded in the present invention, and for those ordinary skilled in the art, other drawings can also be obtained according to these drawings.

FIG. 1 is an overall structural schematic diagram of the present invention;

FIG. 2 is a schematic diagram of the present invention after removal of a main control machine;

FIG. 3 is a schematic diagram of a housing of the present invention;

FIG. 4 is a schematic diagram of a connecting piece of the present invention;

FIG. 5 is a front sectional view of FIG. 2 of the present invention;

FIG. 6 is a decomposed diagram of a torque temperature collection device of the present invention;

FIG. 7 is a schematic diagram of a vibration quantity detection device of the present invention; and

FIG. 8 is a system diagram of the present invention.

### REFERENCE SIGNS

1 housing; 11 installation passage; 12 end cover; 13 protective hood; 14 flange;
2 shaft connecting sleeve; 3 pressing piece; 4 friction plate;
5 connecting piece; 51 connecting part; 52 flange; 53 connecting column; 54 connecting hole;
6 detection mechanism; 61 bearing pedestal; 62 torque temperature collection device; 621 protective box; 622 torque sensor; 623 temperature sensor; 624 second wireless communication module; 625 first single chip microcomputer; 626 signal processing circuit unit; 627 encoder; 628 first power supply; 629 analog/digital conversion unit; 63 vibration quantity detection device; 631 arc bracket; 632 eddy current probe; 633 installation cavity; 634 second single chip microcomputer; 635 second power supply; 636 second wireless communication module;
7 main control machine; 71 display screen; 72 control button panel; 73 buzzer; 74 processor; 75 third wireless communication module.

### DETAILED DESCRIPTION

To better understand the technical solution of the present invention for those skilled in the art, the present invention will be further explained below in detail in combination with the drawings.

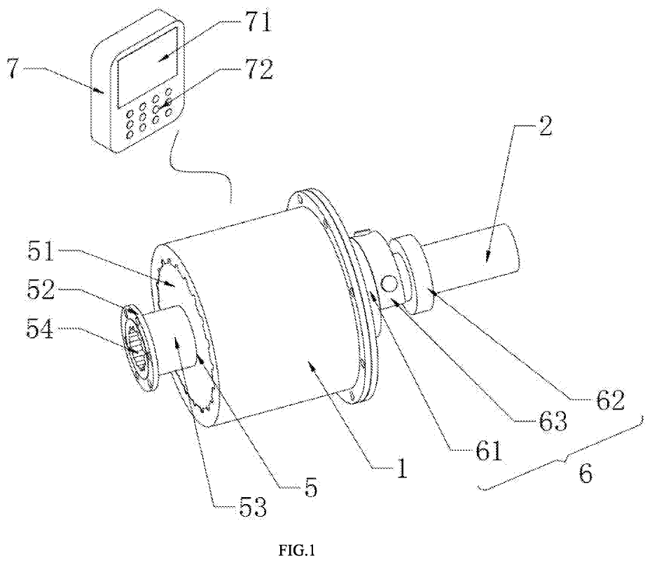

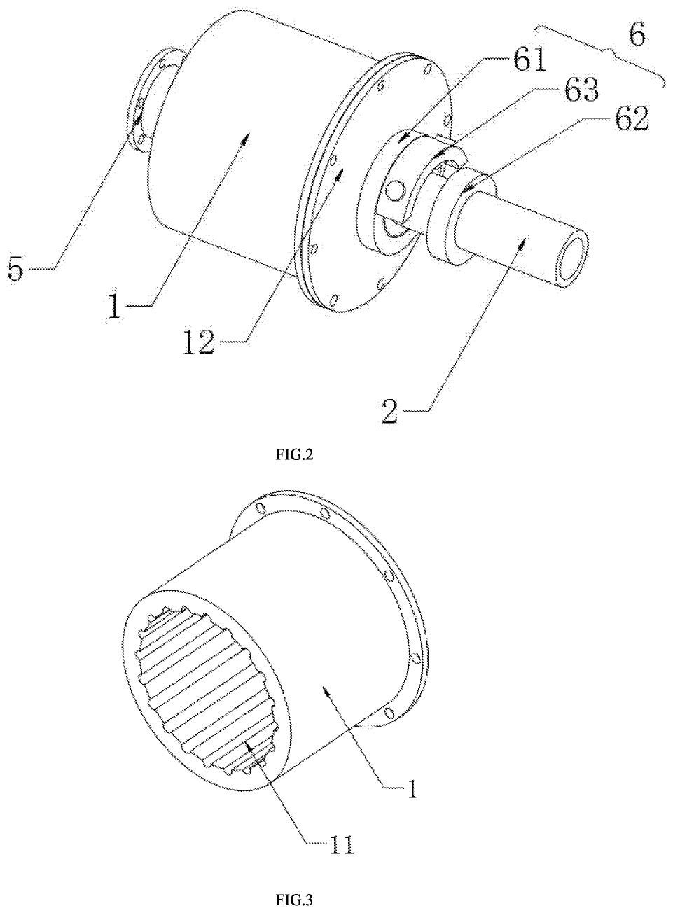

The present invention provides a torque shock load device with a control function as shown in FIG. 1, FIG. 2 and FIG. 5, comprising a housing 1, a shaft connecting sleeve 2, pressing pieces 3, friction plates 4, a connecting piece 5, a detection mechanism 6 and a main control machine 7.

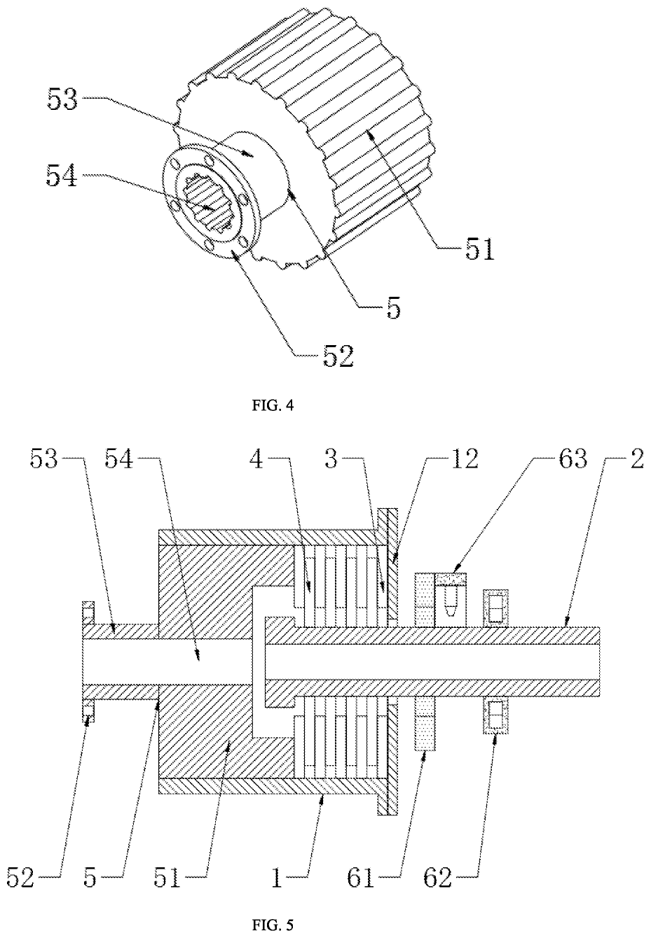

As shown in FIG. 1 to FIG. 5, for the housing 1, the housing 1 is provided with an installation passage 11 penetrating through the housing 1 and the right end of the housing 1 is provided with an end cover 12; for the shaft connecting sleeve 2, the shaft connecting sleeve 2 is movably nested on the right part of the installation passage 11 and the shaft connecting sleeve 2 movably penetrates through the end cover 12; for the pressing pieces 3 and the friction plates 4, the number of the pressing pieces 3 and the number of the friction plates 4 are multiple; a plurality of pressing pieces 3 are installed on the right part of the installation passage 11 through splines; a plurality of friction plates 4 are installed on the shaft connecting sleeve 2 through splines; the plurality of friction plates 4 and the plurality of pressing pieces 3 are arranged alternately; for the connecting piece 5, the connecting piece 5 is installed on the left end of the housing 1; the connecting piece 5 comprises a connecting part 51, a flange 52 and a connecting column 53; the connecting column 53 is installed in the middle of the left side of the connecting part 51; the flange 52 is fixedly sleeved on the left end of the outer side of the connecting column 53; the connecting part 51 is nested in the left part of the installation passage 11; the middle of the connecting column 53 is provided with a connecting hole 54; and the right end of the connecting hole 54 extends to the right side wall of the connecting part 51.

When a power input shaft is connected with the shaft connecting sleeve 2, the connecting piece 5 is connected with a power output shaft; the power output shaft can be inserted into the connecting hole 54 or connected with the flange 52 through bolts; the power input shaft drives the shaft connecting sleeve 2 to rotate; the shaft connecting sleeve 2 drives the housing 1 to rotate through a frictional force between the friction plates 4 and the pressing pieces 3; and the housing 1 rotates to drive the connecting piece 5 to rotate, so as to drive the power output shaft to rotate. When the power input shaft is connected with the connecting piece 5, the power input shaft can be inserted into the connecting hole 54 or connected with the flange 52 through bolts; then the shaft connecting sleeve 2 is connected with the power output shaft; the power input shaft drives the connecting piece 5 to rotate; the connecting piece 5 drives the housing 1 to rotate; the housing 1 rotates, to drive the shaft connecting sleeve 2 to rotate through the frictional force between the pressing pieces 3 and the friction plates 4, so as to drive the power output shaft to rotate; and the friction between the pressing pieces 3 and the friction plates 4 limits a safe transmission torque for shock load protection.

The pressing pieces 3 are connected with the inner wall of the housing 1 through the splines; and the friction plates 4 are connected with the shaft connecting sleeve 2 through the splines. Spline connection stress is relatively uniform, has good working stability, and improves the use reliability of the product. Meanwhile, the spline connection structure is simple, and convenient in installation, disassembly, maintenance and use.

As shown in FIG. 2 and FIG. 5, for the detection mechanism 6, the detection mechanism 6 is installed on the shaft connecting sleeve 2; the detection mechanism 6 is located on the right side of the end cover 12; the detection mechanism 6 comprises a bearing pedestal 61, a torque temperature collection device 62 and a vibration quantity detection device 63; and the vibration quantity detection device 63 is installed on the right side of the bearing pedestal 61.

The torque temperature collection device 62 can detect the temperature and the torque of the shaft connecting sleeve 2, and the vibration quantity detection device 63 can detect the axial and radial vibration quantities of the shaft connecting sleeve 2, thereby realizing detection of the temperature and the torque of the shaft connecting sleeve 2 and detection of the axial and radial vibration quantities of the shaft connecting sleeve 2.

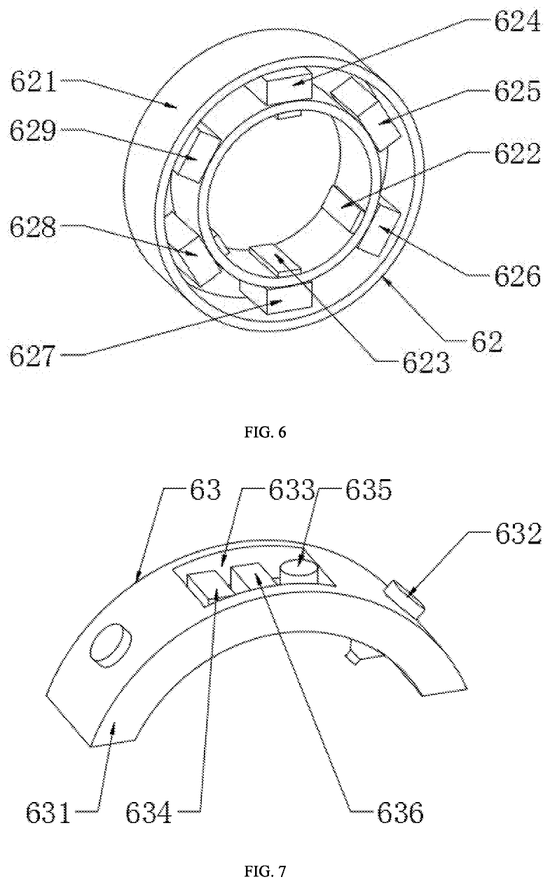

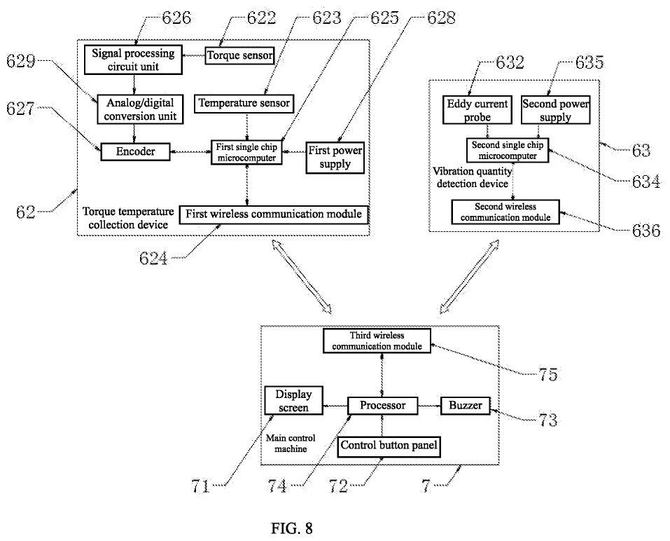

As shown in FIG. 5, FIG. 6 and FIG. 8, the torque temperature collection device 62 comprises a protective box 621, a torque sensor 622 and a temperature sensor 623; a second wireless communication module 624, a first single chip microcomputer 625, a signal processing circuit unit 626, an analog/digital conversion unit 629 and an encoder 627 are installed inside the protective box 621; the output end of the torque sensor 622 is electrically connected with the input end of the signal processing circuit unit 626; the output end of the signal processing circuit unit 626 is electrically connected with the input end of the analog/digital conversion unit 629; the output end of the analog/digital conversion unit 629 is electrically connected with the input end of the encoder 627; the output end of the encoder 627 is electrically connected with the input end of the first single chip microcomputer 625; the output end of the temperature sensor 623 is electrically connected with the input end of the first single chip microcomputer 625; and the first single chip microcomputer 625 is communicatively connected with the main control machine 7 through the second wireless communication module 624. A first power supply 628 is arranged inside the protective box 621. The temperature of the shaft connecting sleeve 2 can be detected through the temperature sensor 623; the torque sensor 622 can collect the twisting force of the shaft connecting sleeve 2 and then send the force to the main control machine 7 through the second wireless communication module 624; and the main control machine 7 can control the work of the torque temperature collection device 62.

The torque sensor 622 detects an electrical torque signal of the shaft connecting sleeve 2; the first single chip microcomputer 625 controls the signal processing circuit unit 626 to extract and amplify an analog signal of the sensor; then, the analog signal is converted through the analog/digital conversion unit 629; then, the encoder 627 conducts corresponding encoding and processing for the collected information data and transmits the information data to the first single chip microcomputer 625; meanwhile, the temperature sensor 623 collects the temperature data of the shaft connecting sleeve 2, and transfers the temperature data to the first single chip microcomputer 625; the first single chip microcomputer 625 wirelessly transmits the torque data and the temperature data of the shaft connecting sleeve 2 to the main control machine 7 through the second wireless communication module 624, to facilitate viewing of customers, facilitate the customers to understand the torque value and the temperature of the shaft connecting sleeve 2 during work, and facilitate the customers to adjust power mechanisms such as a control motor according to the detected torque value and temperature.

As shown in FIG. 5, FIG. 7 and FIG. 8, the vibration quantity detection device 63 comprises an arc bracket 631; the arc bracket 631 is fixed on the right side wall of the bearing pedestal 61; eddy current probes 632 are installed on the arc bracket 631; the number of the eddy current probes 632 is two; two eddy current probes 632 are radially installed in the same plane perpendicular to an axis; the two eddy current probes 632 are arranged by 90 degrees; an installation cavity 633 is arranged inside the arc bracket 631; a second single chip microcomputer 634, a second power supply 635 and a second wireless communication module 636 are arranged inside the installation cavity 633; the output ends of the eddy current probes 632 are electrically connected with the input end of the second single chip microcomputer 634; and the second single chip microcomputer 634 is communicatively connected with the main control machine 7 through the second wireless communication module 636. The two eddy current probes 632 can detect the vibration quantity of the shaft connecting sleeve 2, collect the vibration quantity data of the shaft connecting sleeve 2, and send the data to the main control machine 7 through the second wireless communication module 636; and the main control machine 7 can control the work of the vibration quantity detection device 63.

When the shaft connecting sleeve 2 rotates, the two eddy current probes 632 on the arc bracket 631 detect the shaft connecting sleeve 2; the eddy current probes 632 can accurately measure static and dynamic relative displacement changes between the shaft connecting sleeve 2 and the end surfaces of the eddy current probes 632, and can continuously and accurately collect various parameters of the vibration state of the shaft connecting sleeve 2, such as radial vibration, amplitude and axial position of the shaft connecting sleeve 2; the two eddy current probes 632 send the collected data such as radial vibration, amplitude and axial position of the shaft connecting sleeve 2 to the second single chip microcomputer 634; the second single chip microcomputer 634 sends the data such as radial vibration, amplitude and axial position of the shaft connecting sleeve 2 to the main control machine 7 through the second wireless communication module 636, which is convenient for the customers to view and convenient for the customers to understand the radial vibration, amplitude and axial position of the shaft connecting sleeve 2 during work.

As shown in FIG. 1 and FIG. 8, for the main control machine 7, the main control machine 7 is communicatively connected with the detection mechanism 6.

The surface of the main control machine 7 is provided with a display screen 71 and a control button panel 72; a processor 74 and a third wireless communication module 75 are arranged inside the main control machine 7; the processor 74 is communicatively connected with the third wireless communication module 75; the output end of the processor 74 is electrically connected with the input end of the display screen 71; and the output end of the control button panel 72 is electrically connected with the input end of the processor 74.

A buzzer 73 is arranged inside the main control machine 7, and the output end of the processor 74 is electrically connected with the input end of the buzzer 73. When the detected temperature is too high or the torque is quite different from a set value or the vibration quantity is too large, the buzzer rings to provide an alarm to remind the users, so that the users can conveniently stop the machine for maintenance.

The main control machine 7 can collect data information sent by the detection mechanism 6, the torque temperature collection device 62 and the vibration quantity detection device 63, and display the data information on the display screen 71, which is convenient for the users to view. Moreover, the main control machine 7 can control the work of the torque temperature collection device 62 and the vibration quantity detection device 63. When the detected temperature is too high or the torque is quite different from the set value or the vibration quantity is too large, the processor 74 in the main control machine 7 controls the work of the buzzer 73, and the buzzer 73 rings to provide an alarm to remind the users, so that the users can conveniently stop the machine for maintenance.

As shown in FIG. 3 to FIG. 5, the outer side wall of the connecting part 51 and the inner wall of the installation passage 11 are connected by splines, and the housing 1 and the connecting part 51 are connected by bolts, so that the connection between the connecting part 51 and the housing 1 is firm and stable, and stress is uniform.

The right side surface of the pressing piece 3 located at a rightmost end is abutted against the end cover 12, and the left side surface of the pressing piece 3 located at a leftmost end is abutted against the right side surface of the connecting part 51.

The right side surface of the pressing piece 3 located at a rightmost end is abutted against the end cover 12. The friction plate 4 located at the rightmost end is separated from the end cover 12, to avoid friction due to the contact between the friction plate 4 located at the rightmost end and the end cover 12, reduce the wear of the end cover 12 and increase the service life of the end cover 12. The left side surface of the pressing piece 3 located at a leftmost end is abutted against the right side surface of the connecting part 51. The friction plate located at the leftmost end is separated from the connecting part 51 through the pressing pieces to reduce the wear of the connecting part 51. The outer side wall of the connecting part 51 and the inner wall of the installation passage 11 are connected by splines, and the housing 1 and the connecting part 51 are connected by bolts, so that the connection between the connecting part 51 and the housing 1 is firm and stable, and stress at the connection is uniform. Thus, the connection between the connecting piece 5 and the housing 1 is firm and stable.

Some demonstrative embodiments of the present invention are described above only through the mode of explanation. Undoubtedly, the described embodiments can be corrected in various modes by those ordinary skilled in the art without departing from the spirit and the scope of the present invention. Therefore, the above drawings and illustration are explanatory in nature and should not be interpreted as a limitation to the protection scope of the claims of the present invention.

1. A torque shock load device with a control function, comprising:
a housing (1), wherein the housing (1) is provided with an installation passage (11) penetrating through the housing (1) and the right end of the housing (1) is provided with an end cover (12);
a shaft connecting sleeve (2), wherein the shaft connecting sleeve (2) is movably nested on the right part of the installation passage (11) and the shaft connecting sleeve (2) movably penetrates through the end cover (12);
pressing pieces (3) and friction plates (4), wherein the number of the pressing pieces (3) and the number of the friction plates (4) are multiple; a plurality of pressing pieces (3) are installed on the right part of the installation passage (11) through splines; a plurality of friction plates (4) are installed on the shaft connecting sleeve (2) through splines; and the plurality of friction plates (4) and the plurality of pressing pieces (3) are arranged alternately;
a connecting piece (5), wherein the connecting piece (5) is installed on the left end of the housing (1);
a detection mechanism (6), wherein the detection mechanism (6) is installed on the shaft connecting sleeve (2); and
a main control machine (7), wherein the main control machine (7) is communicatively connected with the detection mechanism (6).

2. The torque shock load device with the control function according to claim 1, wherein the connecting piece (5) comprises a connecting part (51), a flange (52) and a connecting column (53); the connecting column (53) is installed in the middle of the left side of the connecting part (51); the flange (52) is fixedly sleeved on the left end of the outer side of the connecting column (53); the connecting part (51) is nested in the left part of the installation passage (11); the middle of the connecting column (53) is provided with a connecting hole (54); and the right end of the connecting hole (54) extends to the right side wall of the connecting part (51).

3. The torque shock load device with the control function according to claim 2, wherein the outer side wall of the connecting part (51) and the inner wall of the installation passage (11) are connected by splines, and the housing (1) and the connecting part (51) are connected by bolts.

4. The torque shock load device with the control function according to claim 1, wherein the detection mechanism (6) is located on the right side of the end cover (12); the detection mechanism (6) comprises a bearing pedestal (61), a torque temperature collection device (62) and a vibration quantity detection device (63); and the vibration quantity detection device (63) is installed on the right side of the bearing pedestal (61).

5. The torque shock load device with the control function according to claim 4, wherein the torque temperature collection device (62) comprises a protective box (621), a torque sensor (622) and a temperature sensor (623); a first wireless communication module (624), a first single chip microcomputer (625), a signal processing circuit unit (626), an analog/digital conversion unit (629) and an encoder (627) are installed inside the protective box (621); the output end of the torque sensor (622) is electrically connected with the input end of the signal processing circuit unit (626); the output end of the signal processing circuit unit (626) is electrically connected with the input end of the analog/digital conversion unit (629); the output end of the analog/digital conversion unit (629) is electrically connected with the input end of the encoder (627); the output end of the encoder (627) is electrically connected with the input end of the first single chip microcomputer (625); and the first single chip microcomputer (625) is communicatively connected with the main control machine (7) through the first wireless communication module (624).

6. The torque shock load device with the control function according to claim 5, wherein the output end of the temperature sensor (623) is electrically connected with the input end of the first single chip microcomputer (625), and a first power supply (628) is arranged inside the protective box (621).

7. The torque shock load device with the control function according to claim 4, wherein the vibration quantity detection device (63) comprises an arc bracket (631); the arc bracket (631) is fixed on the right side wall of the bearing pedestal (61); eddy current probes (632) are installed on the arc bracket (631); the number of the eddy current probes (632) is two; two eddy current probes (632) are radially installed in the same plane perpendicular to an axis; the two eddy current probes (632) are arranged by 90 degrees; an installation cavity (633) is arranged inside the arc bracket (631); a second single chip microcomputer (634), a second power supply (635) and a second wireless communication module (636) are arranged inside the installation cavity (633); the output ends of the eddy current probes (632) are electrically connected with the input end of the second single chip microcomputer (634); and the second single chip microcomputer (634) is communicatively connected with the main control machine (7) through the second wireless communication module (636).

8. The torque shock load device with the control function according to claim 1, wherein the surface of the main control machine (7) is provided with a display screen (71) and a control button panel (72); a processor (74) and a third wireless communication module (75) are arranged inside the main control machine (7); the processor (74) is communicatively connected with the third wireless communication module (75); the output end of the processor (74) is electrically connected with the input end of the display screen (71); and the output end of the control button panel (72) is electrically connected with the input end of the processor (74).

9. The torque shock load device with the control function according to claim 8, wherein a buzzer (73) is arranged inside the main control machine (7), and the output end of the processor (74) is electrically connected with the input end of the buzzer (73).

10. The torque shock load device with the control function according to claim 2, wherein the right side surface of the pressing piece (3) located at a rightmost end is abutted against the end cover (12), and the left side surface of the pressing piece (3) located at a leftmost end is abutted against the right side surface of the connecting part (51).
